(19) United States
(12) Patent Application Publication
(10) Pub. No.: US 2016/0325132 A1
(43) Pub. Date: Nov. 10, 2016

(54) Exercise Apparatus with Tension Adjustment Mechanism and Dynamo

(71) Applicant: Lauri Monica Nelson, Orlando, FL (US)

(72) Inventor: Lauri Monica Nelson, Orlando, FL (US)

(21) Appl. No.: 15/015,119

(22) Filed: Feb. 3, 2016

Related U.S. Application Data
(60) Provisional application No. 62/111,281, filed on Feb. 3, 2015.

(51) Int. Cl. A63B 21/045; H02K 7/18; A63B 21/00

(52) U.S. Cl. CPC A63B 21/0455; A63B 21/4035; H02K 7/1853

(57) ABSTRACT

An exercise device having a band/cord which extends and retracts from a housing. The apparatus allows users to conduct various physical workout exercises and also to generate electricity. The user is provided a variety of controllable functions related to exercising such as tracking and/or displaying information during the physical workout as well as tracking and displaying information related to the energy generated by the apparatus.

### CROSS-REFERENCE TO RELATED APPLICATIONS

This application claims the benefit of Provisional Application 62/111,281 filed Feb. 3, 2015 which is incorporated by reference in its entirety.

### FIELD OF THE INVENTION

The invention relates to exercise equipment and, more particularly, to a portable exercise apparatus which can be adjusted to suit the strength and level of exertion desired by a person pulling a stretchable cord or band for exercise or therapy. Further, the apparatus includes a dynamo for generating electricity. The electricity generated is stored and/or used by the apparatus as selected by the user. Uses of the electricity generated by the apparatus include powering the instant apparatus, storage internally and/or passing the electricity to external devices—such as mobile phone, tablet computers, a battery, etc.

Generally the apparatus allows users to conduct various physical workout exercises and also to generate electricity.

The invention provides a stretchable cord exercise system comprising a portable tension adjustment device for exercise stretch bands or cords. Although the illustrated embodiments describe use of stretchable cords, ribbon-like stretch bands may be used with the invention as well. The system may be used alone for stretch exercise with a single stretchable cord or may be used in conjunction with other equipment such as an exercise ball.

### BACKGROUND OF THE INVENTION

Exercise devices using a stretchable cord or band to provide a resistive force are available but generally do not provide tension adjustment, selectable electricity generating mode, and selectable use of the generated electricity.

### BRIEF SUMMARY OF THE INVENTION

The Exercise Apparatus with Tension Adjustment Mechanism and Dynamo of the present invention provides a portable exercise apparatus which can be adjusted to suit the strength and level of exertion desired by a person pulling a stretchable cord or band for exercise or therapy. Further, the apparatus includes a dynamo for converting the pulling and retracting of the cord or band into electricity. The electricity generated is stored and/or used by the apparatus as selected by the user. Uses of the electricity available to the user includes using the electricity to power the instant apparatus or using the electricity to charge external devices —such as mobile phone, tablet computers, etc.

The invention provides a stretchable band or cord exercise system comprising a portable tension adjustment device for exercise stretch bands or cords. Although the illustrated embodiments describe use of stretchable cords, ribbon-like stretch bands may be used with the invention as well. The system may be used alone for stretch exercise with a single stretchable cord or may be used in conjunction with other equipment such as an exercise ball.

Further, the instant invention includes a dynamo module for generating electricity as the band(s) or cord(s) are pulled and/or retracted. The dynamo module includes components for generating, storing, and delivering electricity—including components connectable to external devices such as via a USB or Micro-USB port.

Still further, the instant invention includes a control module which allows the user to selectively use the electricity generated by the dynamo module. The control module also controls the display of various information (such as time lapse, calories burned, repetitions, voltage generated, voltage available), and setting electronic controls for adjusting the tension of the device. Note, manual adjustment of the tension of the device is also available.

### BRIEF DESCRIPTION OF THE SEVERAL VIEWS OF THE DRAWINGS

FIG. 1 presents an embodiment of the invention is an apparatus comprising an exercise ball.

FIG. 2 presents an embodiment of the invention is an apparatus comprising an exercise ball.

FIG. 3 presents an embodiment of the invention is an apparatus comprising an exercise ball.

FIG. 4 presents embodiment of the invention is an apparatus comprising an exercise ball.

FIG. 5 presents a side view of the apparatus as attached to an exercise ball.

FIG. 6 presents a front cut-away view of the instant apparatus.

FIG. 7 presents a front view of the instant apparatus.

FIG. 8 presents a view of the cord/band spool of the instant apparatus.

FIG. 9 presents a view of the spool of the instant apparatus.

FIG. 10 presents a front cut-away side view of the instant apparatus.

FIG. 11 presents a view of the pulling mechanism of the instant apparatus.

FIG. 12 presents the control components of the instant apparatus.

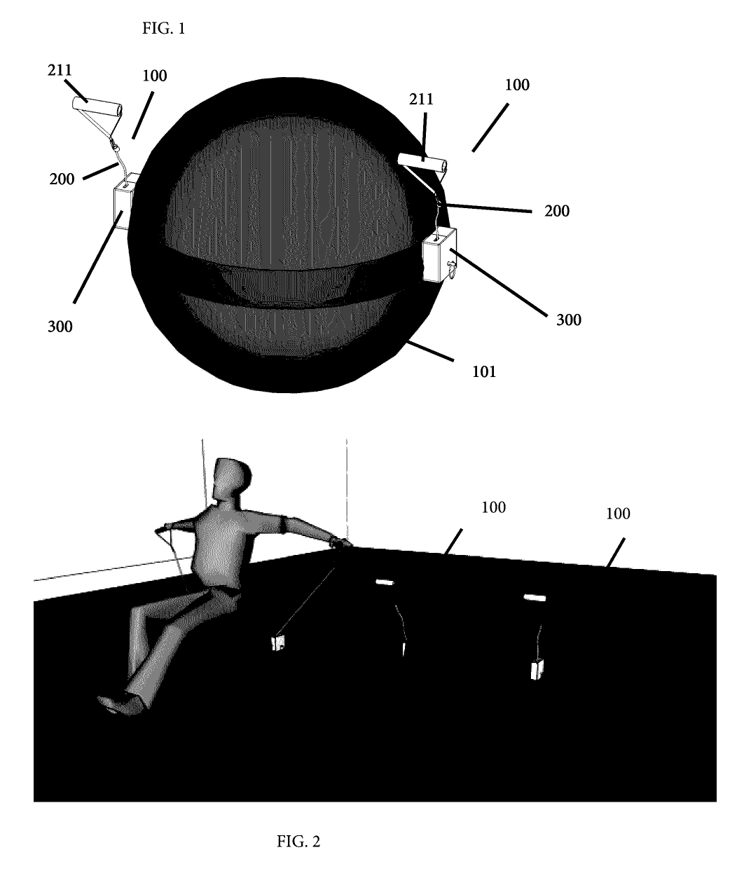

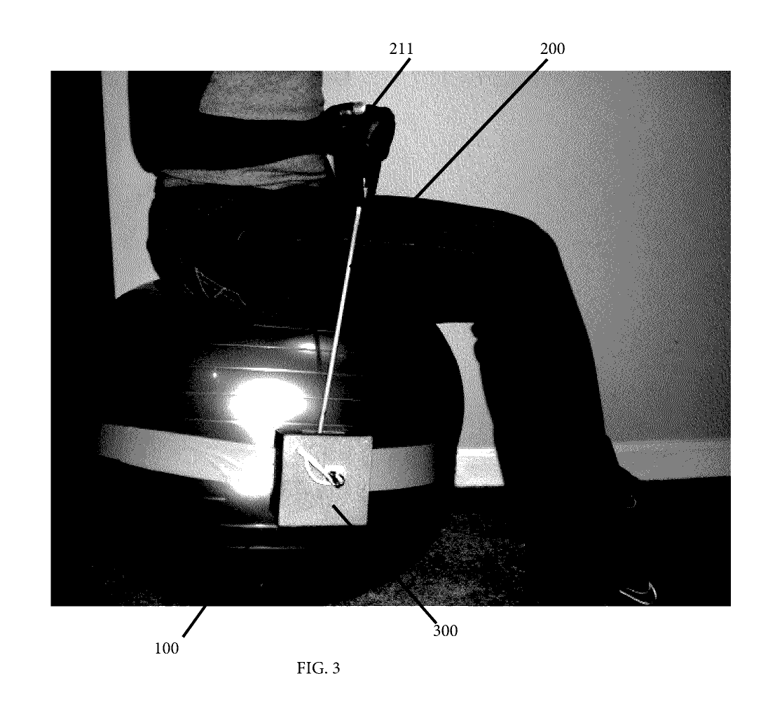

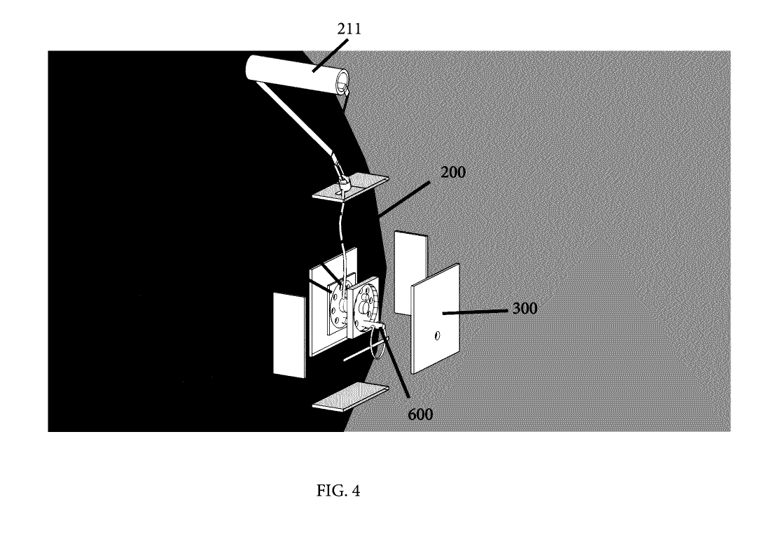

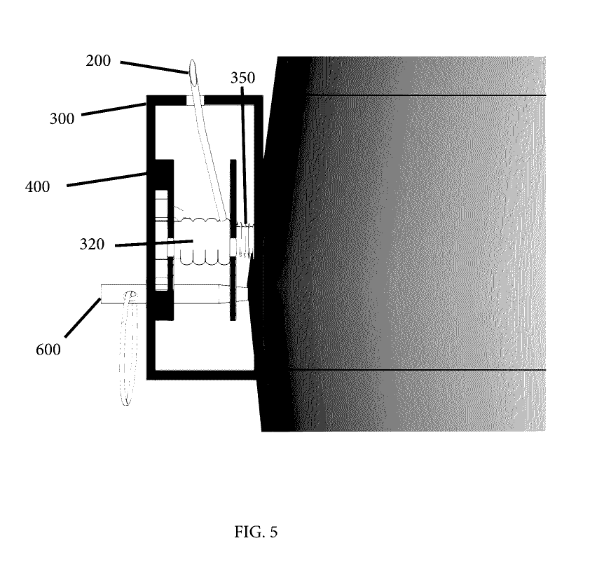

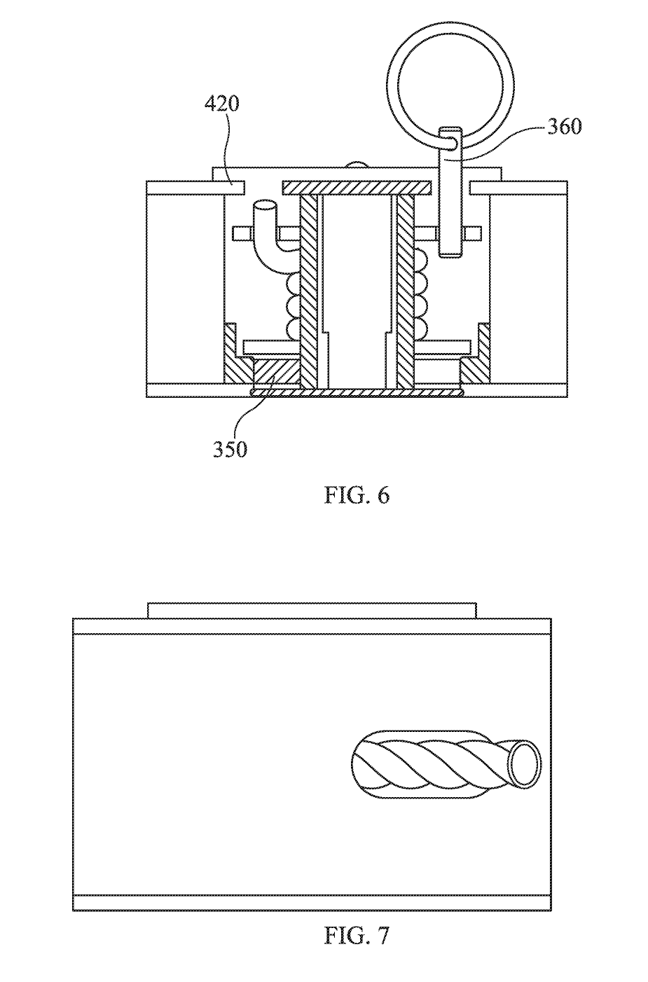

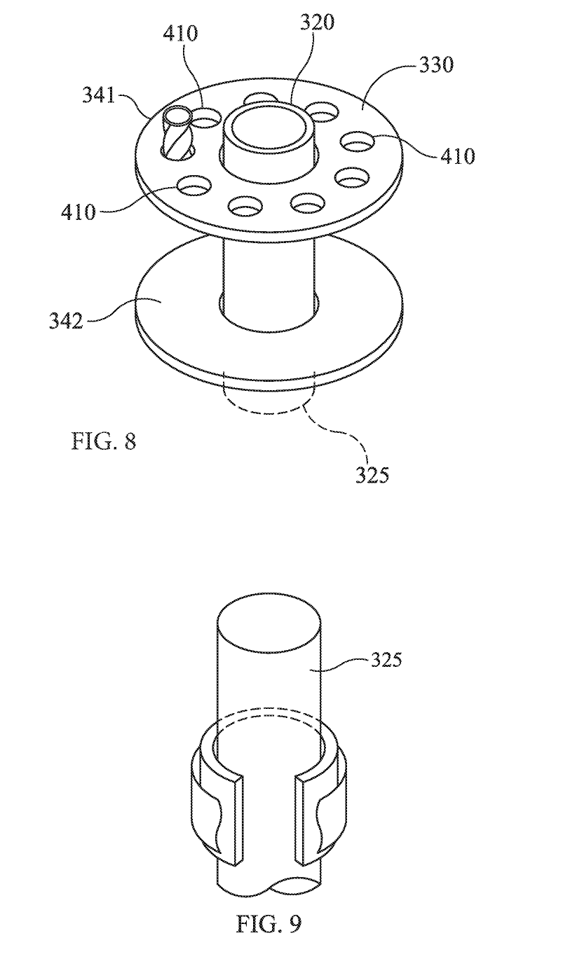

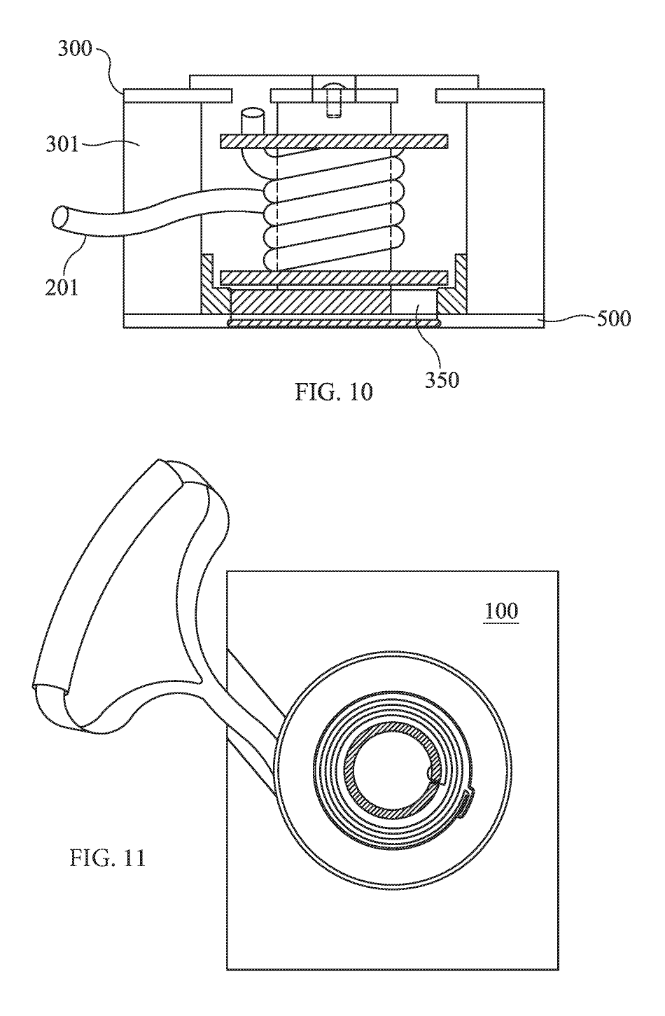

### DETAILED DESCRIPTION OF THE INVENTION

As described herein and presented in the figures, various embodiments of the Exercise Apparatus with Tension Adjustment Mechanism and Dynamo 100 of the present disclosure includes an exercise band/cord 200 which extends and retracts from a housing 300 and subcomponent modules (dynamo module, control module as discussed below). Generally the apparatus allows users to conduct various physical workout exercises and also to generate electricity. The user is provided a variety of controllable functions related to exercising such as tracking and/or displaying information during the physical workout as well as tracking and displaying information related to the energy generated by the apparatus.

In the preferred embodiment of the Exercise Apparatus with Tension Adjustment Mechanism and Dynamo 100 the housing 300 includes at least an enclosure 310 for housing the exercise band 200, a rotatable spool 320 for providing selectable tension, extension, and retraction of the exercise band 200, a dynamo module 400, and a control module 500.

The exercise band/cord 200 is wrapped on the rotatable spool 320 positioned within the housing 300, wherein the housing 300 includes holes 360 provided through at least one surface. A first end 210 of the band 200 extends out of the housing 300 for use during exercise. The first end 210 of the band/cord 200 includes a handle 211 which allows the users to pull the band/cord 200 out of the housing 300. A second end 215 of the band/cord 200 is wound around the rotatable spool 320 thereby forming a pulley 301. The band/cord 200 of the pulley 301 can be pre-tensioned, as desired (or un-tensioned). Users select the pulley 301 which provides desired tension (and therefore resistance to the extension of the band/cord 200) which presents the desired exercise resistance. Users can remove a pulley 301 from the housing 300 and replace with a pulley 301 which has the desired resistive force.

A torsion spring 350 is coupled to a shaft 325 of the rotatable spool 320 to retract the band/cord 200 wherein the spring force of the torsion spring 350 urges rotation of the shaft 325 to wind the exercise band/cord 200 on the shaft 325.

The rotatable spool 320 includes holes 330 provided on an upper disc plate 341 and a lower disc plate 342 (holes optional), wherein the disc plates are connected to the rotatable spool shaft 325.

The disc plates 341, 342 include holes 330 provided through at least one surface.

A pin 600 is inserted into at least one of the holes 330 of the disc plates as well as at least one hole 360 of the housing to prevent rotation of the rotatable spool 320 and thereby selecting the operative length of the band/cord 200 which extends from the housing 300.

Generally, the invention provides an ability to selectively adjust tension desired during an exercise routine by changing the operative length of the band/cord 200 that is being stretched by a person. The term “operative length” as used herein means the length of a relaxed (untensioned) segment of the band/cord 200 which can be stretched during use of the apparatus.

The operative length of the band/cord 200 is approximately the length of the band/cord 200 (in the relaxed state) between the handle 211 and the spool 320. The operative length can be increased by dispensing further portions of the band/cord 200 from the spool 320 or decreased by winding further portions of the band/cord 200 on to the spool 320.

The dynamo module 400 includes a plurality of magnets 410 (preferably but not necessarily permanent magnets) inserted into some of the holes 330 provided on the rotatable spool 320. Dynamo module 400 includes a plurality windings 420 provided on the housing 300 and positioned to periodically interact with the magnets 410 on the rotatable spool 320.

Generally, as the band/cord 200 is pulled away from the housing 300 or retracts into housing 300 the rotatable spool 320 rotates the magnets 410 on the spool 320 rotate past the plurality windings 420 provided on the housing 300. This rotation of the magnets 410 past the plurality windings 420 generates an electrical current in the applicable winding 420.

Note—alternate methods for rotating the rotatable spool 320 are envisioned (such as a manual hand crank adapter or a driven crank adapter—not shown) to generate electricity and are understood to be within the disclosed the uses and applications of the instant apparatus.

The dynamo module 400 includes known mechanical or electronic components 401 (such as rectifiers, inductions, transistors, integrated circuits, resisters, light emitting diodes, etc) for conditioning the electricity generated by the pulling or retracting of the band/cord 200.

The dynamo module 400 further includes known mechanical or electronic components 402 for storing and distributing the electricity generated by the pulling or retracting of the band/cord 200.

The control module 500 provides a user interface 510 (such as a display panel, user buttons and switches, audio output components, etc). The control module 500 further includes software to control various features such as selecting the operational mode of the instant invention, translating the mechanical extension and/or retraction of the band/cord 200 and/or the rotation of the rotatable spool 320 into data which can be displayed or used to control features and functions of the invention.

For example, as the band/cord 200 is pulled, the control module 500 translates the movement of the extension of the band/cord 200 into a force indication which can be displayed to the user on the display panel. Note the extension of the band/cord 200 may generate linear or non-linear signals which the control module 500 translates into the applicable data or and/or presents as indication on the user interface 510 or housing 300.

Also as the rotatable spool 320 is rotated, the control module 500 calculates the electricity generated and can display the information to the user on the display panel.

Note the rotation of the rotatable spool 320 may generate linear or non-linear signals which the control module 500 translates into the applicable data or and/or presents as indication on the user interface 510 or housing 300.

The Exercise Apparatus with Tension Adjustment Mechanism and Dynamo 100 of the present disclosure may include any of an array of sensors and input output devices, such as those available in common mobile phones, including wired and wireless communication components (such Wi-FI, RF, WAN, LAN, IEEE compliant elements, acoustic devices, optic devices, and motion detection devices). Further, two or more of the instant apparatuses may communicate with each other or with other devices.

The instant apparatus uses known internal data storage components and can be connected to addition external data storage as desired.

The instant apparatus can be used with a variety of accessories including those with sensors and those which use the electricity provided by the instant apparatus.

The instant apparatus uses known internal electricity storage components and can be connected to addition external electricity storage components as desired (i.e., the instant invention can send and/or receive electricity via a USB or other known electrical interface component.

Note the tracking elements of the instant apparatus and/or its surrounding is performed using commonly known sensor devices such as biological sensors, environmental sensors, accelerometers, gps systems, satellite systems, open-loop calculations, closed-loop calculations, visual data, acoustic data, pre-programmed routines, iteratively developed routine, sua sponte (real-time) developed, etc.

The software provided in the instant apparatus performs a host of functions including, but not limited to, collecting data during usage which tracks the extension and retraction and motion of the band/cord 200 or the handle 211 and the motion of the housing, calculating exercise data, control communications between the instant apparatus and external devices, analyze workout performance, and monitor external sensors such as biofeed back sensors.

The specific sequence of functions performed by the software is related to the selected configuration of the instant apparatus. Users may follow pre-programmed routines (such as by following a workout routine crafted to integrate with the input and output components of the instant apparatus) or users may manually select and execute users options such as via selection from a menu provided on the user interface 510.

Note—two or more of the instant apparatuses may be connected to each other or to other devices including a ball 101, wall, chair, person, tree, door, structure, vehicle, or generally any object which affords an area for secure attachment.

While differing uses may require a unique combination of the above input, output, and attachment elements, specific combinations of the above components are considered anticipated within the scope of the instant apparatus. For example (not for limiting purposes), while a first user of the Exercise Apparatus with Tension Adjustment Mechanism and Dynamo 100 may select a configuration which includes a WI-Fi component, external energy storage device, external data storage device, and an audible alert component, a different user of the Exercise Apparatus with Tension Adjustment Mechanism and Dynamo 100 device may chose his/her version which has a wired communications component and only internal data and energy storage components. Both of the preceding configurations and others are considered within the scope of the instant apparatus.

Operational Modes

The Exercise Apparatus with Tension Adjustment Mechanism and Dynamo 100 provides three key operational modes. Mode 1 is the mechanical only workout mode; Mode 2 is the electricity generating mode; Mode 3 the electricity or data transfer or evaluation mode. Mode 3 may simultaneously be selectively performed during Mode 1, or Mode 2.

In Mode 1 the primary function of the apparatus is to provide resistance used during a workout session. Primarily the resistance is a function of the elasticity of the operative length of the band/cord 200 of the selected pulley 301. Users are provided a range of resistances available via each pulley 301. The user simply pulls on the handle 211 which then draws the band/cord 200 out of the housing 300 and the resistance provided by the elasticity of the band/cord 200 requires the user to exert force to overcome the resistance. The correlation between the elasticity of the band/cord 200 and the force exerted to overcome the resistance can be used to determine the amount of work done by the user. The amount of work can be converted into units such as calories burned by the user. Additionally the apparatus may track other information such as the number of repetitions and the speed at which the band/cord 200 was pulled.

Further, the user can select the operative length (and thus the resistance to pulling) of the selected band/cord 200 by positioning pin 600 in at least one of the holes 330 of the disc plates as well as at least one hole 360 of the housing to prevent rotation of the rotatable spool 320.

In Mode 2 the pin 600 is not used and therefor the rotatable spool 320 rotates as the band/cord 200 is extended and/or retracted. The rotation of the rotatable spool 320 rotates the plurality of magnets 410 inserted into some of the holes 330 provided on the rotatable spool 320. The movement of the plurality of magnets 410 past the plurality windings 420 provided on the housing 300 generates electricity. The user pulls the handle 211 to extend the band/cord 200 and the spring force of the torsion spring 350 urges rotation of the shaft 325 to wind the exercise band/cord 200 on the shaft 325 to retract the handle 211 and band/cord 200.

Selection of the desired pulley 301 determines how much effort is required to extend the exercise band/cord 200 and thus how much work is needed to generate electricity.

The control module 500 tracks movement of the band/cord 200 and calculates the amount of electricity generated. The control module 500 makes the electricity available for other uses such as providing electricity to the apparatus and/or storing it within a battery (internal or external) or passing the electricity along to external devices.

Securing the rotation of the rotatable spool 320 with respect to the housing 300 may be provided by other known locking mechanisms such as a pair of magnets, a mechanical latch, a solenoid, a clamp, and a locking strap/chain.

In Mode 3 the user may or may not be simultaneously using the device as described in Mode 1 or Mode 2. Mode 3 relates to the evaluating or controlling the electricity and/or data transfer.

In Mode 3 users can review the amount of electricity generated and decide how to use the electricity or the user may decide to continue using the apparatus to generate more power. Users can selectively enable device features (such as turning on audible alerts or visual indicators).

In Mode 3 users can select to have the electricity generated (or stored) passed along to external devices via the USB or Micro-USB ports or similar interface devices which allow the apparatus to connect to external devices.

In Mode 3 users can configure options such as setting the apparatus to display the calories burned, heat rate, the current date/time, the lap time of usage, the number of extension and/or retraction repetitions of the handle 211 or the exercise band/cord 200.

Note—by counting the number of extension and/or retraction repetitions of the handle 211 or the exercise band/cord 200, the instant apparatus can be attached to external equipment such as exercise equipment and used to track the movement of the external equipment. For example, the handle can be attached to a bench press bar and track the number of times the bar goes up and down thereby counting the repetitions. When a force sensor is provided within the instant apparatus, the amount of force exerted when raising and/or lowering the bench press bar can also be tracked. When an accelerometer is provided within the instant apparatus or a sensor in communication with the instant apparatus the speed at which the bench press bar is raised or lower can be tracked.

The instant apparatus can store data such as data from previous workout(s) by, for example, including date and time data with each data sample.

The foregoing disclosure is sufficient to enable one having skill in the art to practice the apparatus without undue experimentation, and provides the best mode of practicing the apparatus presently contemplated by the inventor. While there is provided herein a full and complete disclosure of the preferred embodiments of this apparatus, it is not intended to limit the apparatus to the exact construction, dimensional relationships, and operation shown and described. Various modifications, alternative constructions, changes and equivalents will readily occur to those skilled in the art and may be employed, as suitable, without departing from the true spirit and scope of the apparatus. Such changes might involve alternative materials, components, structural arrangements, sizes, shapes, forms, functions, operational features or the like. Elements of the instant apparatus may be made from a variety of known materials including wood, rubber, metal, or plastic, as well as from any suitable combination of appropriate materials.

Accordingly, the proper scope of the present apparatus should be determined only by the broadest interpretation of the appended claims so as to encompass all such modifications as well as all relationships equivalent to those illustrated in the drawings and described in the specification.

What is claimed is:

1. An exercise apparatus comprising a housing, an extendable cord extending from the housing, a module for adjusting the cord, and an electricity generating module within the housing, wherein in extending and retracting the cord generates electricity.
